(19) United States
(12) Patent Application Publication
(10) Pub. No.: US 2007/0253794 A1
(43) Pub. Date: Nov. 1, 2007

(54) FASTENING DEVICE

(75) Inventors: JUN ZHANG, Shenzhen (CN); ZHENG SHI, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,995

(22) Filed: Dec. 22, 2006

(30) Foreign Application Priority Data
Apr. 28, 2006 (CN) 200610060507.1

(51) Int. Cl. F16B 13/06

(52) U.S. Cl. 411/45

(57) ABSTRACT

A fastening device for combining plate-like pieces together is provided. Each piece defines a through hole. The fastening device includes a locking member, and a locking pin. The locking member includes a sleeve. At least one pressing portion and a plurality of legs are formed on two opposite ends of the locking member. The legs are configured for extending through the through holes of the pieces. At least one slot is defined in the sleeve. The locking pin includes a foot capable of being inserted in the sleeve to expand the legs. At least one block is formed on the foot. The locking pin is pressable and then turnable relative to the locking member to cause the foot inserting into the space to deform the legs to splay for sandwiching the pieces by cooperating with the pressing portion and the block being locked into the slot to engage the locking pin to the locking member.

### BACKGROUND OF THE INVENTION

1. Field of the Invention

The present invention relates to fastening devices, and particularly to a fastening device for combining plate-like pieces together.

2. Description of Related Art

A typical fastening device for combining two plate-like pieces together includes a locking pin. At least two elastic legs extend from an end of the locking pin. Each leg forms a clasp on a free end thereof. A head is formed on an opposite end of the locking pin. Each plate-like piece defines a through hole. The head of the locking pin presses a surface of one of the two pieces. The legs extend through the through holes of the two pieces, and the clasps engage with the edge of the through hole of the other piece. However, this type of fastening device is hard to detach from the pieces. It is inconvenient for users.

What is desired, therefore, is a fastening device readily detached from plate-like pieces.

### SUMMARY OF THE INVENTION

An exemplary fastening device for combining plate-like pieces together is provided. Each piece defines a through hole. The fastening device includes a locking member, and a locking pin. The locking member includes a sleeve. At least one pressing portion and a plurality of legs are formed on two opposite ends of the locking member. The legs are configured for extending through the through holes of the pieces. At least one slot is defined in the sleeve. The locking pin includes a foot capable of being inserted in the sleeve to expand the legs. At least one block is formed on the foot. The locking pin is pressable and then turnable relative to the locking member to cause the foot inserting into the space to deform the legs to splay for sandwiching the pieces by cooperating with the pressing portion and the at least one block being locked into the at least one slot to engage the locking pin to the locking member.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a fastening device in accordance with a preferred embodiment of the present invention;

FIG. 2 is an inverted view of FIG. 1;

FIG. 3 is an assembled view of the fastening device with two plate-like pieces ready to be combined together; and

FIG. 3 is an assembled view of the fastening device with two plate-like pieces combined together.

### DETAILED DESCRIPTION OF THE INVENTION

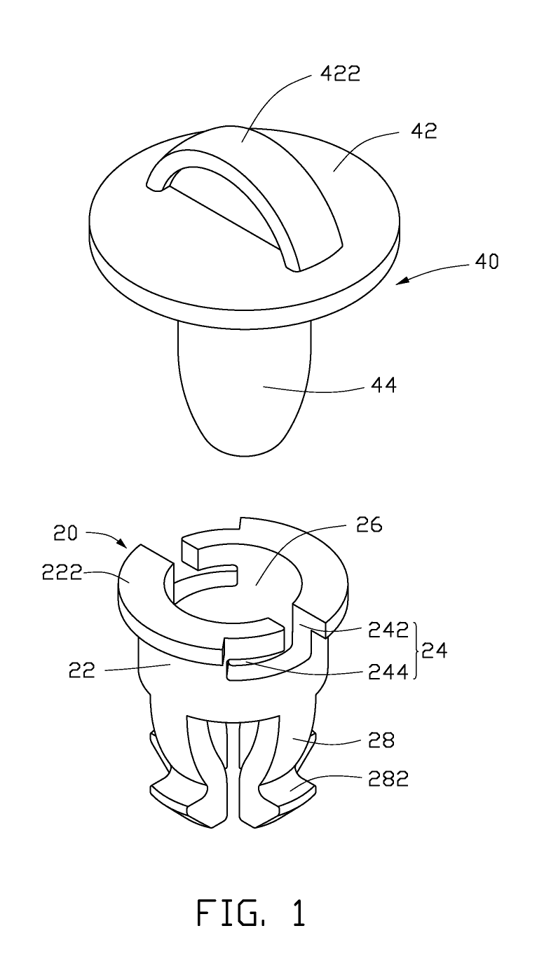

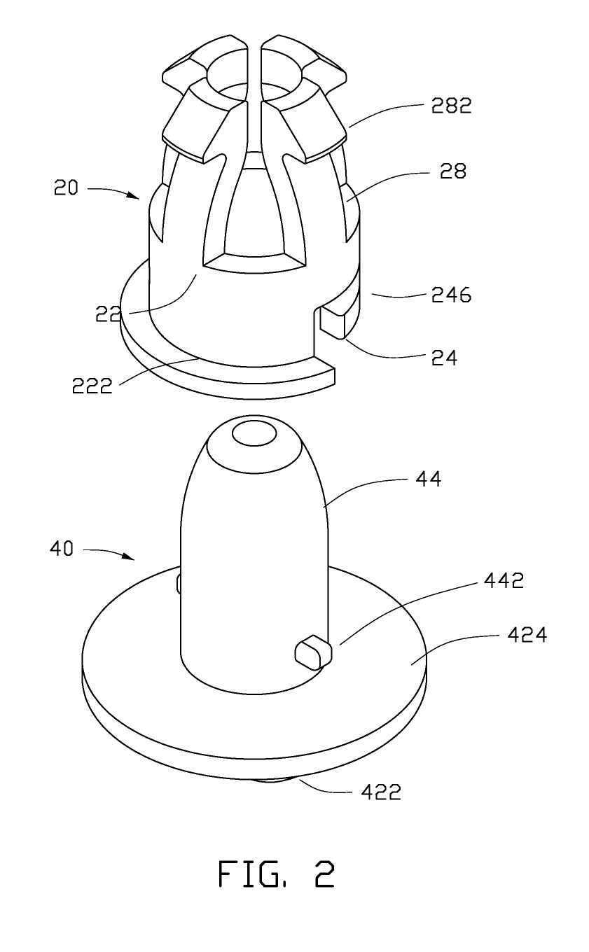

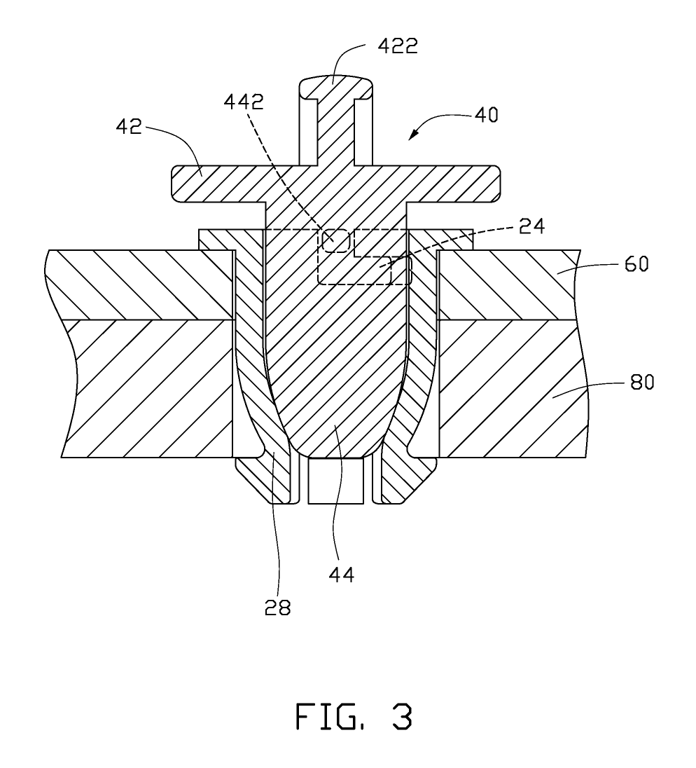

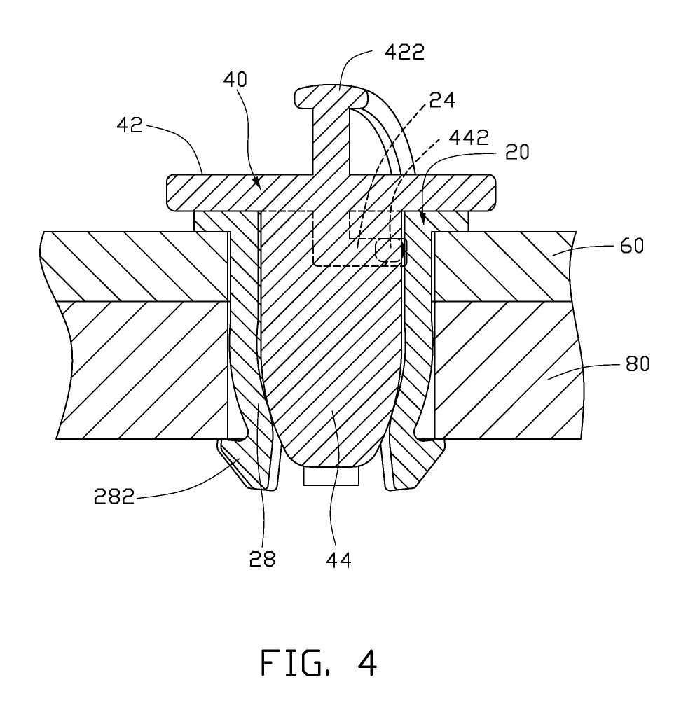

Referring to FIGS. 1 and 2, a fastening device in accordance with a preferred embodiment of the present invention is shown. The fastening device is used for combining two plate-like pieces 60, 80 (shown in FIG. 3) together. Each piece 60,80 defines a through hole therein. The fastening device includes a locking member 20, and a locking pin 40.

The locking member 20 forms a sleeve 22 on an upper portion thereof. Two L-shaped slots 24 are defined in the sleeve 22 by vertically and then horizontally cutting from an end edge into an end of the sleeve 22. Each slot 24 includes a vertical opening 242, and a horizontal groove 244. A cantilevered portion 246 is formed adjoining each slot 24, and the cantilevered portion 246 is generally located above the groove 244 of each slot 24. Two pressing portions 222 extend from the end of the locking member 20. A lower surface of each pressing portion 222 is flat, for pressing an upper surface of the piece 60. A receiving space 26 is defined by an inner surface of the sleeve 22. A plurality of spaced elastic arcuate legs 28 extends from an opposite end of the sleeve 22. Each leg 28 forms a clasp 282 on a free end thereof. When in a normal state, the free ends of the legs 28 slant toward each other so that inner surfaces of the legs 28 define a generally taper-shaped space.

The locking pin 40 includes a head 42, and a foot 44. The head 42 comprises a round plate and a cambered handle 422 formed on an upper surface of the plate. The foot 44 extends from a lower surface of the plate of the head 42. The foot 44 is a cylinder tapered toward a free end, corresponding to the space defined by the legs 28 of the locking member 20, but having a diameter larger than a diameter of the space defined by the legs 28 of the locking member 20 in a normal state. Two blocks 442 are formed on a surface of the foot 44, adjacent the head 42. Each block 442 corresponds to a slot 24 of the locking member 20.

Referring to FIGS. 3 and 4, in attaching the plate-like pieces 60, 80 together, the through hole of the piece 60 aligns with the through hole of the piece 80. The legs 28 of the locking member 20 extend through the through holes of the pieces 60, 80, and the clasps 282 of the legs 28 extend out from the through holes of the pieces 60, 80. The lower surfaces of the pressing portions 222 contact the upper surface of the piece 60. The foot 44 of the locking pin 40 is inserted into the receiving space 26 of the locking member 20. The blocks 442 of the locking pin 40 align with the corresponding openings 242 of the slots 24 of the locking member 20. The head 42 of the locking pin 40 is pressed down to insert the free end of the foot 44 into the space defined by the legs 28 of the locking member 20. The foot 44 presses against the inner surfaces of the legs 28. The legs 28 are distorted to splay outward and the clasps 282 of the legs engage the edge of the through hole of the piece 80. The head 42 abuts against the pressing portions 222 of the locking member 20. The handle 422 is turned clockwise by an external force. The blocks 442 are locked into the grooves 244 of the slots 24. When the external force is removed, the legs 28 slightly restore to press the tapered free end of the foot 44 of the locking pin 40 to push the locking pin 40 upward. The blocks 442 of the locking pin 44 tightly engage with the corresponding cantilevered portions 246 of the locking member 20. Thus, the locking pin 40 cannot be accidentally turned to disengage from the locking member 20 because of friction between the locking pin 40 and the corresponding cantilevered portions 246 of the locking member 20. Thus, the pieces 60, 80 are tightly attached together.

In detaching the pieces 60, 80, the locking pin 40 is pressed down. The handle 422 is turned counterclockwise. The blocks 442 are disengaged from the grooves 244. The locking pin 40 is moved up under restoring forces of the legs 28 of the locking member 20. The legs 28 restore to their normal state at which the legs 28 are not deformed and are extendable the through holes of the pieces 60, 80 and the clasps 282 disengage from the piece 80. Thus, the pieces 60, 80 are ready to be detached from each other.

In other embodiments, the fastening device can be used for combining three or more plate-like pieces, each defining a through hole.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A fastening device for combining plate-like pieces together, each of the pieces defines a through hole, the fastening device comprising:
a locking member comprising a sleeve, at least one pressing portion and a plurality of elastic legs formed on two opposite ends of the locking member, the at least one pressing portion configured for pressing a surface of one of the pieces, the legs configured for extending through the through holes of the pieces, at least one slot defined in the sleeve; and
a locking pin comprising a foot capable of being inserted in the sleeve to expand the legs for tightly engaging a surface of another of the pieces opposing said surface of one of the pieces, at least one block formed on the foot, the at least one block locked into the at least one slot to engage the locking pin to the locking member.

2. The fastening device as claimed in claim 1, wherein the at least one slot is L-shaped and defined in the sleeve of the locking member by vertically and then horizontally cutting from an end edge into an end of the sleeve, the at least one slot comprises a vertical opening and a horizontal groove, at least one cantilevered portion is formed adjoining the at least one slot and located above the groove of the at least one slot, the at least one block of the locking pin is capable of passing through the vertical opening to enter into and be locked in the groove of the at least one slot and tightly engage with the at least one cantilevered portion.

3. The fastening device as claimed in claim 1, wherein a receiving space is defined between the legs of the locking member, the foot of the locking pin is inserted into the receiving space.

4. The fastening device as claimed in claim 1, wherein each of the legs forms a clasp on a free end thereof, the clasp is configured for engaging the surface of the another of the pieces.

5. The fastening device as claimed in claim 1, wherein the locking pin forms a handle thereon for facilitating turning the locking pin relative to the locking member to allow the at least one block being locked into the at least one slot.

6. The fastening device as claimed in claim 5, wherein the locking pin further comprises a head, the foot extends from a surface of the head, and the handle is formed on an opposite surface of the head.

7. A fastening device for combining plate-like pieces together, the fastening device comprising:
a locking member comprising at least one pressing portion, and a plurality of elastic legs, free ends of the legs becoming gradually closer to each other so that inner surfaces of the legs cooperatively define a taper-shaped space; and
a locking pin being rotatable relative to the locking member between a locked position and an unlocked position, the locking pin comprising a foot, in the locked position the foot inserted into the space defined by the legs and urging against the inner surfaces of the legs to distort the legs to splay for sandwiching the pieces by cooperating with the at least one pressing portion of the locking member, wherein when the locking pin is rotated relative to the locking member to the unlocked position the legs restore to push the foot upward.

8. The fastening device as claimed in claim 7, wherein the foot of the locking pin is a cylinder tapered toward a free end, corresponding to the space defined by the legs of the locking member, but having a diameter larger than a diameter of the space defined by the legs of the locking member in a normal state where the legs are not deformed and are extendable through holes defined in the pieces.

9. The fastening device as claimed in claim 8, wherein the locking member comprises a sleeve, the at least one pressing portion is formed on an end of the sleeve, the legs extend from an opposite end of the sleeve, at least one slot is defined in the sleeve, at least one block is formed on the foot of the locking pin, and the at least one block is locked into the at least one slot to engage the locking pin to the locking member.

10. The fastening device as claimed in claim 9, wherein the at least one slot is L-shaped, the at least one slot comprises a vertical opening for providing an access for the at least one block entering into the at least one slot and a horizontal groove along which the at least one block slides when the locking pin rotates relative to the locking member, at least one cantilevered portion is formed adjoining the at least one slot and located above the groove of the at least one slot, the at least one block of the locking pin is locked into the groove of the at least one slot and tightly engage with the at least one cantilevered portion.

11. The fastening device as claimed in claim 8, wherein the locking pin forms a handle thereon for facilitating turning the locking pin.

12. The fastening device as claimed in claim 1, wherein the locking pin further comprises a head, the foot extends from a surface of the head, and the handle is formed on an opposite surface of the head.

13. The fastening device as claimed in claim 7, wherein each of the legs forms a clasp on a free end thereof.

14. A fastening device for combining plate-like pieces together, the fastening device comprising:
a locking member comprising a pressing portion, and a plurality of elastic legs configured to extend through the pieces, the legs cooperatively defining a space therebetween;
a locking pin comprising a foot being insertable into the space; and
a combined block and slot respectively formed in the locking member and the locking pin,
wherein the locking pin is pressable and then turnable relative to the locking member to cause the foot inserting into the space to deform the legs to splay for sandwiching the pieces by cooperating with the pressing portion of the locking member and the block being blocked in the slot to prevent the locking pin disengaging from the locking member.

15. The fastening device as claimed in claim 14, wherein the slot is L-shaped and comprises a vertical opening and a horizontal groove, the block passes through the vertical opening when the locking pin is pressed and enters into the horizontal groove when the locking pin is turned.

16. The fastening device as claimed in claim 15, wherein the block is formed at the locking pin and the slot is defined in the locking member.

17. The fastening device as claimed in claim 16, wherein the block abuts against the locking member upward in the horizontal groove to prevent the blocking escaping from the groove when the block is locked in the slot.

18. The fastening device as claimed in claim 17, wherein the pressing portion extends outward from an end of the locking member and comprises a cantilever portion adjacent the slot and above the horizontal groove, the blocks abutting against the cantilever upward in the horizontal groove when the block is locked in the slot.

19. The fastening device as claimed in claim 15, wherein each of the legs forms a clasp at a distal end thereof, the clasping being configured to cooperate with the pressing portion to sandwich the pieces therebetween.

20. The fastening device as claimed in claim 18, wherein the locking member comprises a sleeve integrally formed between the pressing portion and the legs, the sleeve having a uniform cylinder shape, the legs becoming gradually closer to each other toward the clasps so that the space has a taper shape, the foot of the locking pin having a taper-shaped free end.
